(19) United States
(12) Patent Application Publication
(10) Pub. No.: US 2014/0229317 A1
(43) Pub. Date: Aug. 14, 2014

(54) KIOSK FOR EXTRACTING GEOMETRIC ELEMENTS OF A KEY, MAPPING TO A MASTER KEY-CODE DATABASE, AND SAVING DATA INTO A CUSTOMER'S LOYALTY ACCOUNT

(71) Applicants: Adam Philip Fagan, Rockville, MD (US); Gary Arnold Cohen, Baltimore, MD (US)

(72) Inventors: Adam Philip Fagan, Rockville, MD (US); Gary Arnold Cohen, Baltimore, MD (US)

(21) Appl. No.: 13/766,728

(22) Filed: Feb. 13, 2013

(51) Int. Cl. G06Q 30/06

(52) U.S. Cl. CPC G06Q 30/0621
USPC 705/26.5

(57) ABSTRACT

A method and application provides a universal key code for use when a key is lost. The code can be taken to a locksmith or retailer for duplication. The user can take their key to a kiosk located, for example, at a merchant's location. The kiosk can have the ability to extract a digital image of their key and a software application can extract unique key geometries from the key, via, for example, edge detection technology and/or other mathematical methods, digital image processing methods and standard image processing methods. A key code can be determined from this extracted information and mapped to a known key code database. The software application can output the key blank and key cut code to allow a consumer to simply and conveniently obtain a duplicate key. This information can be saved into a customer's loyalty account with a particular merchant for later retrieval as needed.

### BACKGROUND OF THE INVENTION

The present invention relates to a key code system and, more particularly, to a kiosk for allowing a customer to use proprietary mathematical methods, digital image processing and standard image processing to extract critical geometric elements of a key, map to a master key-code database, and save their key data to their store loyalty account. The customer can use their loyalty account to have a replacement key sent to the merchant for pick up.

Currently, an original key is necessary to make a copy of the key. If the original is lost, no copy can be made unless the key code is available or by using a locksmith.

Keys are able to be cut from a key-code. For each manufacturer of a keyed system, a specific key blank can fit into the key cylinder. The specific cuts can be measured and recorded into a database. Each entry in this database can have a specific key code assigned thereto. Most consumers, however, do not know the key code assigned to their key. There is currently no way for a user to obtain such a key code for future duplication from the key itself.

As can be seen, there is a need for a method and application for extracting geometric elements from a key and mapping these elements to a master key-code database, allowing a consumer to obtain a copy of a key without having the original by simply accessing their loyalty account with a merchant.

### SUMMARY OF THE INVENTION

In one aspect of the present invention, a method for saving information about a user's key, comprises receiving the key into a key insertion window of a kiosk; extracting geometric information from the key; matching the geometric information to a key code in a key code database; and storing the key code to a merchant loyalty account of a user.

In another aspect of the present invention, a kiosk comprises one or more input/output devices to provided information to and received information from a user; a key insertion window permitting insertion of a key therein; at least one sensor, such as a digital camera or digital scanner, to obtain geometric information from the key; and a communication module to access an account of the user, upon user entry of a username and password, and save the geometric information from the key into the account of the user.

In a further aspect of the present invention, a method for providing a loyalty program account that saves a user's key geometry information comprises receiving the key into a key insertion window of a kiosk; extracting geometric information from the key; matching the geometric information to a key code in a key code database; obtaining account sign-in information from the user to access the user's loyalty program account, or requiring the user to establish a new account; and saving the key code to the loyalty program account of the user to request a replacement key be sent to the merchant for pick up.

These and other features, aspects and advantages of the present invention will become better understood with reference to the following drawings, description and claims.

### BRIEF DESCRIPTION OF THE DRAWINGS

FIG. 1 is a schematic view showing a method for obtaining a duplicate key according to an exemplary embodiment of the present invention;

FIG. 2 is a perspective view of an exemplary kiosk according to an exemplary embodiment of the present invention;

FIG. 3 is a detailed perspective view of a key insertion window in the kiosk of FIG. 2;

FIG. 4 is a schematic representation of various internal components and processes of the kiosk of FIG. 2;

FIG. 5 is an enlarged view of a key for which the method and application of the present invention can determine a key-code therefore; and

FIG. 6 is an enlarged detail view of a key, showing exemplary measurements determined by the application and method of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides methods and applications for extracting the universal key code and key blank for use when a key is lost. The user can take their key to a kiosk located, for example, at a merchant's location. The kiosk can have the ability to take a digital image or scanned image of their key and a software application can extract unique key geometries from the key, via, for example, edge detection technology and/or other mathematical methods, digital image processing methods and standard image processing methods. A key code can be determined from this extracted information and mapped to a known key code database. The software application can output, from a digital image or scan of an original key, the key blank and key cut code to allow a consumer to simply and conveniently obtain a duplicate key. This output can be saved into a customer's loyalty account with a particular merchant for retrieval.

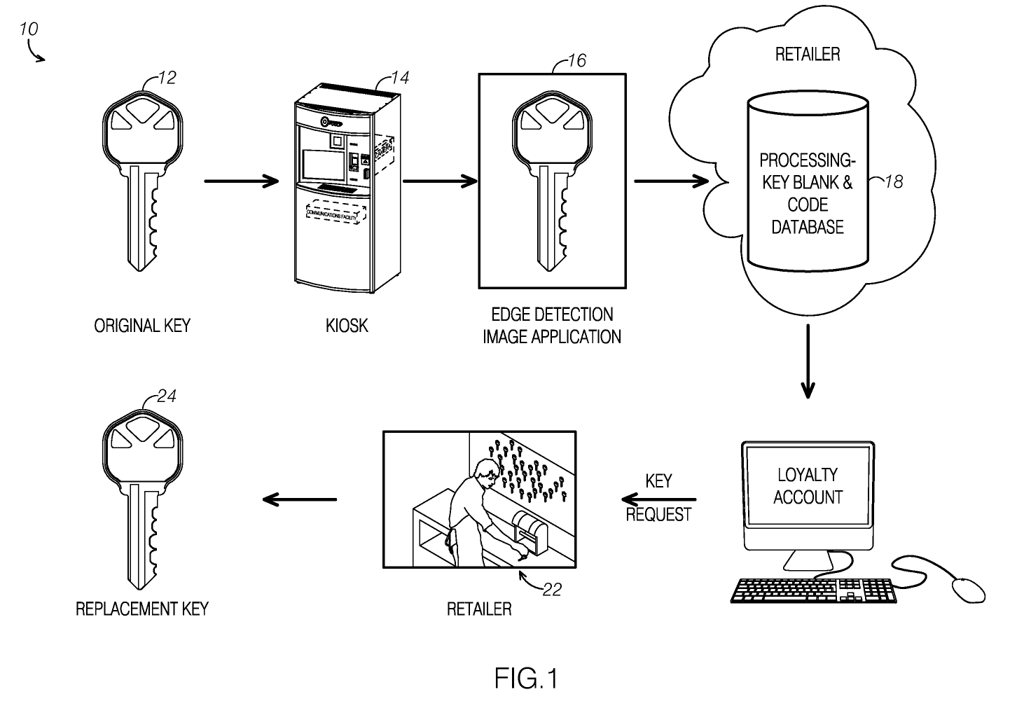

Referring now to FIG. 1, a method 10 is shown for obtaining a replacement key 24 from a digital image or scan 16 of an original key 12. A kiosk 14 can be used to extract the digital image or scan 16 of the original key 12. Software can include algorithms to extract geometric features of the key. The algorithm can take the extracted geometric features and compare such features to a key blank and key code database. The algorithms can include histogram analysis to determine the background color and compute the vector of that color, a vector keying algorithm to remove the background and generate a binary (black and white) mask that outlines the objects in the image, and other methods, such as contour maps, thresholding, edge-detection and perhaps other similar technologies. The software can reside on a computing device 18 that receives the photographed or scanned image taken by the kiosk embedded device, such as a digital camera or digital scanner, processes the image as described above, and outputs a key blank and cut code to be stored at the customers merchant loyalty account.

Thus, the kiosk can provide the user with key blank and cut codes. The customer can opt to have the key blank and cut codes saved in their loyalty account with a particular merchant.

If the user loses their key, they can simply provide a retailer or locksmith 22 their blank and key code information and a replacement key 24 can be prepared. In some embodiments, the user may be able to sign into their merchant loyalty account on-line and request a duplicate key be made at the local location of that merchant. Then, the customer can simply present appropriate identification to the merchant to obtain their duplicate key. Security policies will give the option of either delivering the key code and blank information to the user or securely storing the key code and blank information at the merchant loyalty account. In the latter, the customer will not have access to the key code information but will have the ability to have a replacement key sent based on the stored key blank and code information.

The loyalty account can retain information about each of the user's keys. The account can include methods for labeling each key blank and code information with key identification information. For example, if a user loses their shed lock door key, they can look on their account and open the file related to the shed lock door to find their blank is a M1 master lock blank and their key code is 12345. The retailer or locksmith can use this information to easily and quickly provide a duplicate key.

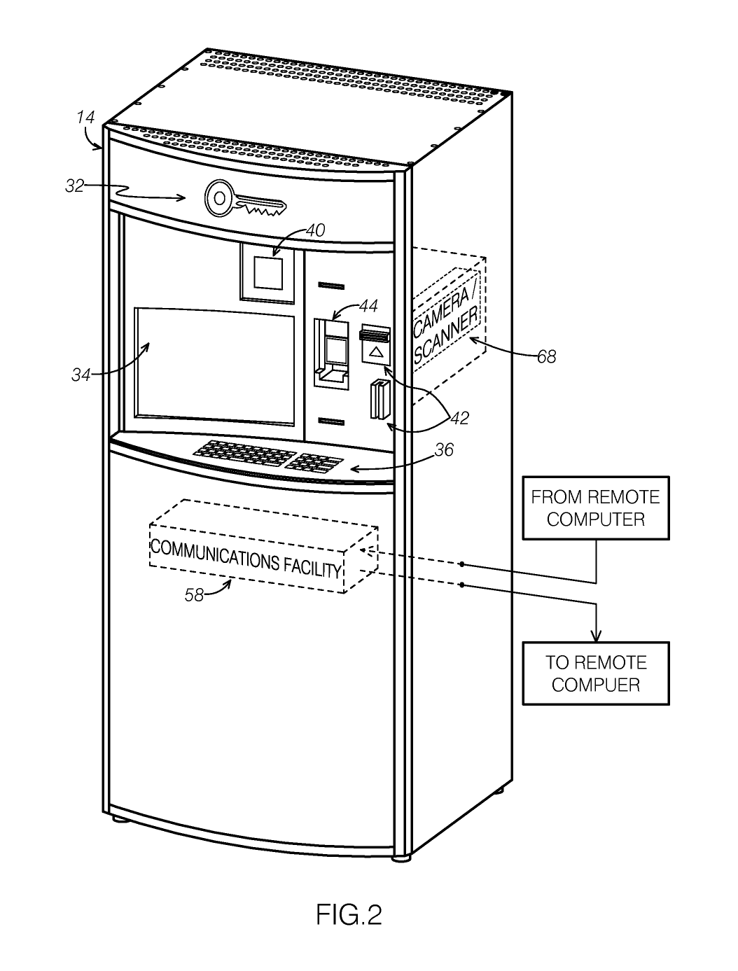

Referring now to FIGS. 2 through 4, the kiosk 14 can include an identification panel 32 that can, for example, describe the function of the kiosk, include the merchant brand information, or the like. Various input/output devices can be configured to allow a user to input information. For example, a video monitor 34 can provide information. The monitor 34 can be, for example, a touch screen display, providing not only video output, but an option for user input. An additional touch screen or keyboard 36 can be provided for user input. In addition, various buttons, knobs, pointers, track balls, or the like, can be provided to allow user input as well.

A key insertion window 44 can be provided in the kiosk 14 to allow a user to input their key 12. The key insertion window 44 can allow insertion of the key 12 and the kiosk 14 can contain an internal digital camera or digital scanner 68, or other such device, to obtain the image and determine the key blank and key code, as described in greater detail below.

When associated with a merchant loyalty type of program, the kiosk 14 can be designed to enroll new users into the program or allow key information to be saved to the user's existing account. A card slot 42 can be provided for a user to input their loyalty card to allow key information to be saved to their account. The kiosk 14, via the various input/output devices, can allow a user to sign up for a new loyalty member card instantly.

The kiosk 14 can include various audio/video devices 40 such as microphones and speakers so that live help can be obtained for a user of the kiosk. Other communication devices, such as cameras and the like can also be used to provide both security and communications. The audio/video devices 40 can be linked to the communication module 58, described below, to send/receive signals via, for example, an internet connection.

Various security features can be incorporated to prevent unauthorized access to one's account. For example, a password or pin may be required to access an account (either via the kiosk 14 or, for example, through the internet via another computing device). The kiosk 14 can be set up with various security technology, such as password protection, biometric scanning, or the like.

The kiosk 14 as described above allows key identification to be saved to a user account, such as a merchant loyalty account. The function of the kiosk 14 can be further expanded to include other functions. For example, in some embodiments, the kiosk 14 can include a key duplication function, where a user can simply insert their loyalty card, select a key associated with their account, and automatically have that key duplicated.

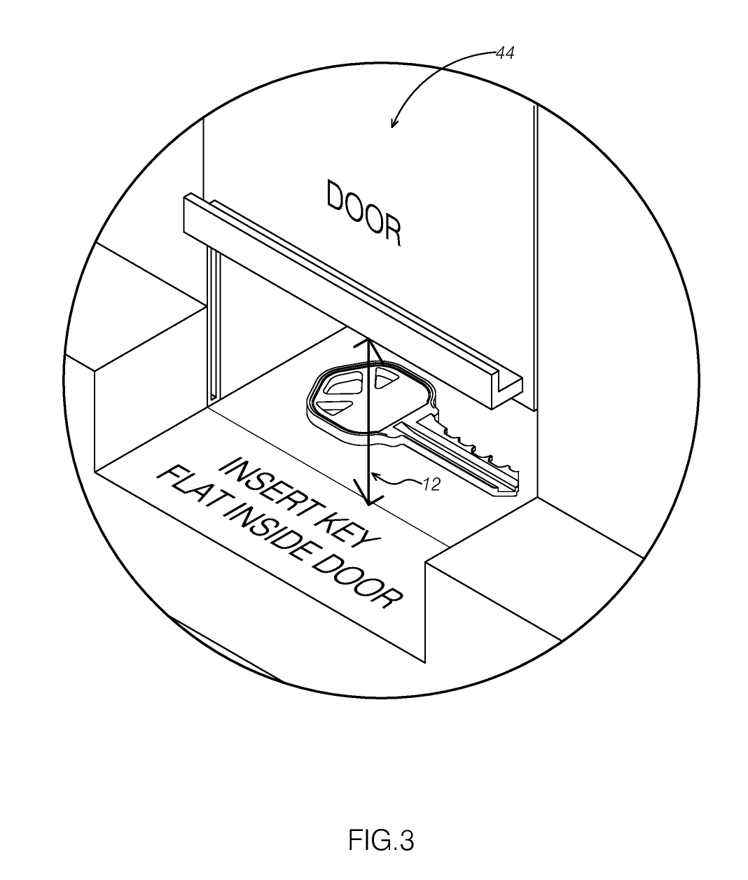

Referring to FIG. 3, a detailed view of the key insertion window 44 is shown. In some embodiments, the user would be required to insert the key in a particular configuration, as shown. In other embodiments, the kiosk 14 would include the necessary elements to detect the insertion direction and read the necessary key features and geometries, regardless of insertion orientation.

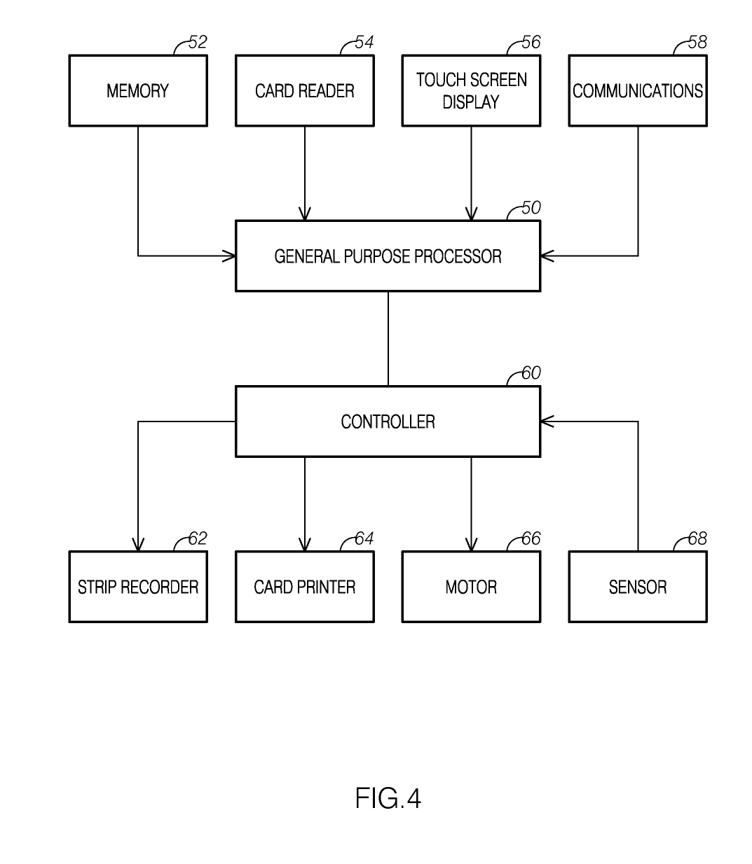

Referring now to FIG. 4, the kiosk 14 can include various hardware and software to provide for the functions as herein described. For example, the kiosk 14 can include a processor 50 for controlling the kiosk function. The processor 50 can interact with a memory module 52 (for storing software applications for performing the various functions, for example), a card reader 54 (for reading a customer loyalty card, for example), a touch screen display 56 and a communications module 58. The communications module 58 may be configured to access a centralized database for key code information, user account information, or the like.

The kiosk 14 can also include a controller 60 for controlling various physical features of the present invention. The controller 60 can include a magnetic strip recorder 62 and a card printer 64 for generating loyalty cards for new users, and various motors 66 and sensors 68 to provide other necessary functions of the machine. For example, the sensors 68 may include a digital camera or digital scanner for determining the key blank type and the key geometries, as described below.

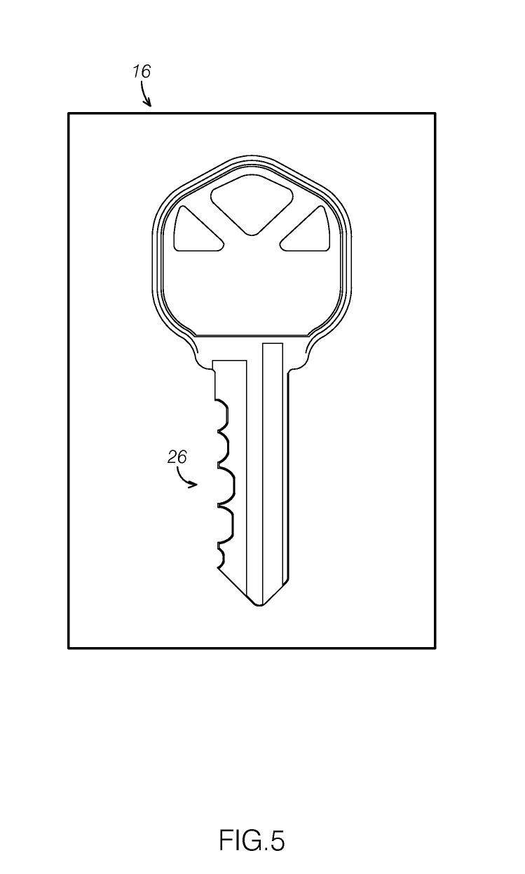

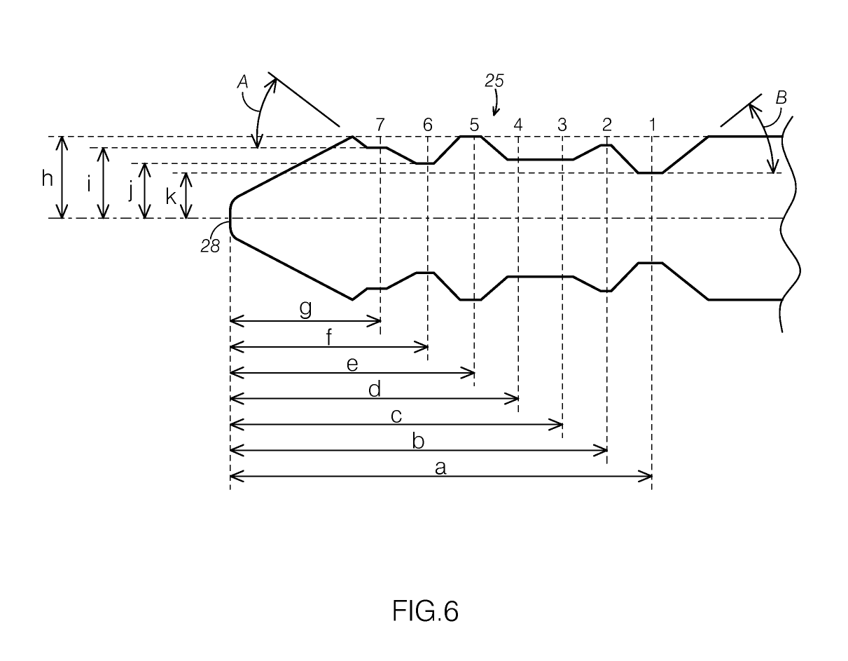

Referring to FIGS. 5 and 6, the picture 16 of the key, from which mathematical methods, digital image processing methods and standard image processing methods can obtain key geometries, can include a side view of the blade 26 of the key 12. As shown in detail in FIG. 6, the application of the present invention can measure various angles, A, B, and also measure various longitudinal dimensions a-g associated with spaces 1-7 of the blade 26 as well as transverse dimensions h-k associated with depths of cut on the blade 26. While FIG. 8 shows exemplary geometries extracted by the software of the present invention, other measurements may be used, depending on the type of key, for example.

The above refers to using mathematical methods, digital image processing methods and standard image processing methods for processing the image to obtain key geometries. These methods can include edge detection technology, Histogram Analysis, Vector Keying, Contour Maps, Thresholding, and the like, to determine the necessary geometric information.

While the above refers to a kiosk application that determines a key blank and key code from a digital image taken with a digital camera or digital scannner the methods and software of the present invention could be applied to different electronic and computing devices. For example, a digital camera or digital scanner could be used to create a digital image and a desktop computer, laptop computer, tablet computer, smartphone or mobile device could be used to process the uploaded image and determine the geometric information of the key.

It should be understood, of course, that the foregoing relates to exemplary embodiments of the invention and that modifications may be made without departing from the spirit and scope of the invention as set forth in the following claims.

What is claimed is:

1. A method for saving information about a user's key, comprising:
receiving the key into a key insertion window of a kiosk;
extracting geometric information from the key;
matching the geometric information to a key code in a key code database; and
linking information about a user's key to a merchant loyalty account of a user.

2. The method of claim 1, further comprising providing the key code to the merchant loyalty user account of the user or providing a replacement key through the merchant.

3. The method of claim 1, further comprising extracting a digital image of the key.

4. The method of claim 1, further comprising determining a key blank of the key.

5. The method of claim 1, wherein mathematical methods, digital image processing technology and standard image processing technology is used to extract the geometric information.

6. The method of claim 1, further comprising adding a new key code to the key code database when the geometric information cannot be matched to an existing key code.

7. The method of claim 1, wherein the key code database is an existing key code database.

8. A kiosk comprising:
one or more input/output devices to provided information to and received information from a user;
a key insertion window permitting insertion of a key therein;
at least one sensor to obtain geometric information from the key; and
a communication module to access an account of the user, upon user entry of a username and password, and save the geometric information from the key into the account of the user.

9. The kiosk of claim 8, wherein the one or more input/output devices include a touch screen.

10. The kiosk of claim 8, further comprising a card reader slot operable to read a loyalty card of a user to permit access to the account of the user.

11. A method for providing a loyalty program account that saves a user's key geometry information, the method comprising:
receiving the key into a key insertion window of a kiosk;
extracting geometric information from the key;
matching the geometric information to a key code in a key code database;
obtaining account sign-in information from the user to access the user's loyalty program account, or requiring the user to establish a new account; and
securely saving the key code to the loyalty program account of the user.

12. The method of claim 11, further comprising determining a key blank of the key.

13. The method of claim 11, wherein mathematical methods, digital image processing technology and standard image processing technology is used to extract the geometric information.

14. The method of claim 11, further comprising adding a new key code to the key code database when the geometric information cannot be matched to an existing key code.
